(19) United States
(12) Patent Application Publication
(10) Pub. No.: US 2014/0168967 A1
(43) Pub. Date: Jun. 19, 2014

(54) Lighting Batten and Lighting System

(71) Applicant: Toshiba Lighting & Technology Corporation, Yokosuka-shi (JP)

(72) Inventor: Kazuaki Itami, Yokosuka-shi (JP)

(73) Assignee: TOSHIBA LIGHTING & TECHNOLOGY CORPORATION, Yokosuka-shi (JP)

(21) Appl. No.: 13/955,034

(22) Filed: Jul. 31, 2013

(30) Foreign Application Priority Data
Dec. 17, 2012 (JP) 2012-275022

(51) Int. Cl. F21V 21/15

(52) U.S. Cl. CPC F21V 21/15
USPC 362/233

(57) ABSTRACT

According to one embodiment, a lighting batten includes: a communication section for communicating with an external apparatus using a predetermined communication protocol; a plurality of connectors to which a plurality of lighting devices which have identification information and device information, and output a response signal when receiving an inquiry signal are connected; a plurality of relay sections; a plurality of signal direction detection sections which are provided corresponding to the plurality of connectors, respectively; and a position detecting section. The position detecting section generates and outputs installation position information of the lighting device having the identification information, based on the predetermined detection signals output from the signal direction detection sections when the response signal in response to a the predetermined inquiry signal to the lighting device from an operation console is output to any of the plurality of relay sections.

### CROSS-REFERENCE TO RELATED APPLICATION

This application is based upon and claims the benefit of priority from the Japanese Patent Application No. 2012-275022, filed on Dec. 17, 2012; the entire contents of which are incorporated herein by reference.

### FIELD

Embodiments described herein relate generally to a lighting batten and a lighting system.

### BACKGROUND

In a lighting system of a theater, a stage, a studio or the like of the related art, a lighting batten in which a plurality of lighting devices are installed is used. For example, a plurality of lighting devices such as a spot light are connected to the lighting batten and the lighting batten is hung by a ceiling or the like. The light modulation control is performed on each of the lighting devices of each batten depending on a scene or the like.

The lighting device which is used or an installation position thereof usually differs depending on a program, an event or the like on the stage or the like. Therefore, in the lighting system for controlling the lighting device, installation of the lighting device is changed for every change of the program or the like.

On the other hand, in a light modulation console for controlling the light modulation, a mapping of each lighting device to an actuator such as an illumination fader is performed for every installation change thereof.

In a case of a configuration in which the light modulation console and the plurality of lighting battens are connected to each other via a light modulation control board which is directly connected to each lighting device and supplies power to each lighting device, a correlation between each lighting device and each actuator in the light modulation console can be relatively easily grasped and the mapping thereof can be easily set.

However, in a case of a configuration in which the light modulation console and the plurality of lighting battens are connected to each other via communication lines and a light modulation signal is transmitted via the communication lines, there is a problem that the type of each lighting device and the installation position of each lighting device in each lighting batten cannot be easily grasped, and the mapping of each actuator to each lighting device in an operation console cannot be easily set.

In order to grasp the type and the installation position of each lighting device, a system is proposed which can easily grasp the state of the installation change of the lighting device by identifying the lighting device connected to the batten using an information chip such as an RFID tag. In this case, the information chip is affixed to all lighting devices and an information chip reading device is attached to all battens.

However, in such a system, since a work for writing necessary information in all information chips is generated in addition to the attachment of such an information chip to all lighting devices, there is a problem that a lot of time and efforts are taken for a preparation work.

### BRIEF DESCRIPTION OF THE DRAWINGS

FIG. 1 is a configuration view of a lighting system according to an embodiment.

FIG. 2 is a block diagram illustrating a configuration of a batten 3 according to the embodiment.

FIG. 3 is a circuit diagram of a signal direction detection section 27 according to the embodiment.

FIG. 4 is a flowchart illustrating an example of a flow of an acquisition process of a UID in the batten 3, according to the embodiment.

FIG. 5 is a flowchart illustrating an example of a flow of a process for acquiring installation position information of each lighting device 6 in an operation console 2, according to the embodiment.

FIG. 6 is a flowchart illustrating an example of a flow of a process when receiving a transmission request command for device information or the like in each node 11, according to the embodiment.

FIG. 7 is a view illustrating an example of a lighting device information table TBL stored in a storage section 2b of the operation console 2, according to the embodiment.

FIG. 8 is a view illustrating an example of a screen showing a lighting device arrangement on a stage that is displayed on the screen of a display section 2d of the operation console 2, according to the embodiment.

### DETAILED DESCRIPTION

In general, according to one embodiment, a lighting batten includes: a communication section for communicating with an external apparatus using a predetermined communication protocol; a plurality of connection sections to which a plurality of lighting devices which have identification information and device information and output a response signal when receiving an inquiry signal are connected; a plurality of signal relay sections which are connected to the plurality of corresponding connection sections; a plurality of signal direction detection sections which are provided corresponding to the plurality of connection sections, respectively, each of the plurality of signal direction detection sections outputting a predetermined detection signal when detecting a signal which is transmitted respectively from each of the plurality of connection sections to each of the plurality of signal relay sections; and an installation position information output section which generates and outputs installation position information of one of the plurality of lighting devices having the identification information, when the response signal in response to the predetermined inquiry signal to each of the plurality of lighting devices having the identification information is output to any of the plurality of signal relay sections, from the external apparatus, based on the predetermined detection signal which is output from the signal direction detection section.

Hereinafter, the embodiment is described with reference to the drawings.

Configuration

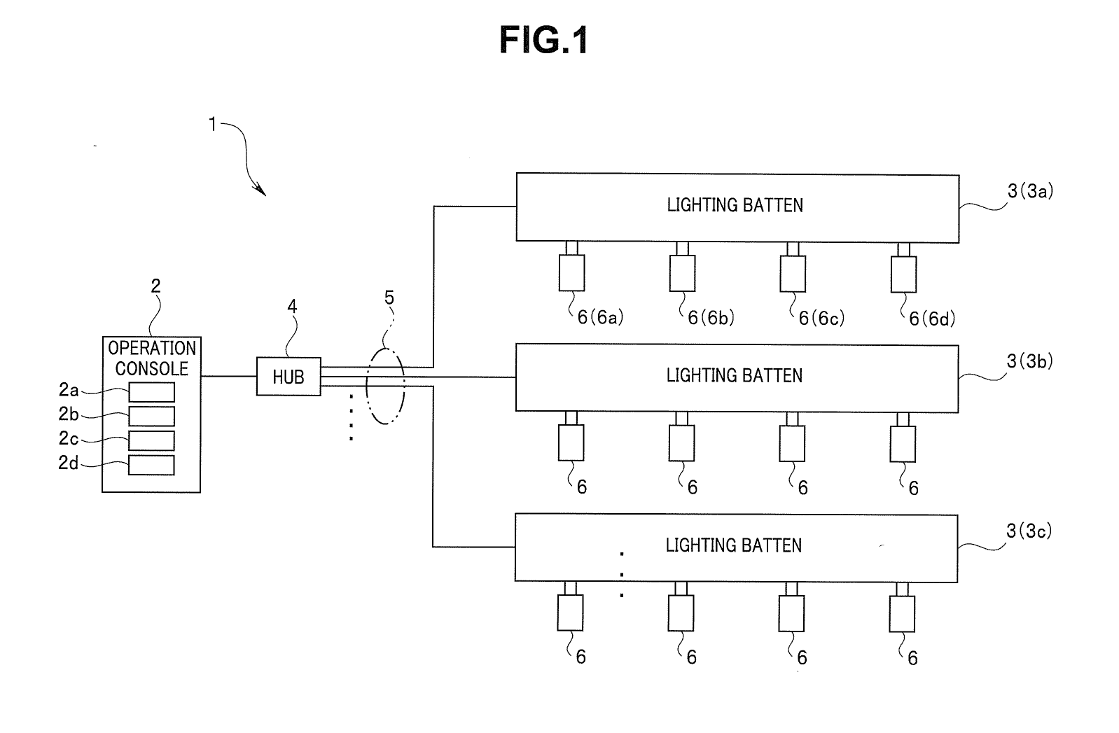

FIG. 1 is a configuration view of a lighting system according to the embodiment. A lighting system 1 includes an operation console 2 and a plurality of lighting battens 3. The operation console 2 and the plurality of lighting battens 3 are connected to each other by communication lines 5 via a hub 4. A plurality of lighting devices 6 can be attached to each of the lighting battens 3. The lighting device 6 is a lighting device using a light emitting diode (LED) in this case. Certainly, the lighting device 6 may be a lighting device using another light source.

The operation console 2 and each of the lighting battens (hereinafter, simply referred to as the batten) 3 are capable of communicating with each other using a communication protocol via the communication line 5, for example, Ethernet (registered trademark). Thus, the operation console 2 has address information of each of the battens 3. The communication line 5 is a line for data communication between the operation console 2 and each of the battens 3. In addition, power supply to each of the lighting devices 6 of the batten 3 is supplied via a power supply line (not illustrated).

The operation console 2 has a control section 2a including a central processing unit (hereinafter, referred to as a CPU), a storage section 2b for storing various types of data, an input section 2c for inputting various settings and light modulation operations, and a display section 2d that is a monitor. The operation console 2 has a light modulation actuator such as a fader which is a part of the input section 2c to perform light modulation of each of the lighting devices 6. An operator can manually control the light modulation of any of the lighting devices 6. Furthermore, the operation console 2 can automatically transmit a light modulation signal to each of the lighting devices 6 depending on scenes in a pre-programmed order.

Herein, in order to simplify the description, each of the battens 3 is assumed to be configured such that four lighting devices are attachable at predetermined positions.

The plurality of battens 3 are installed on the stage or the like, the operation console 2 is installed in a control room or the like and the lighting system 1 is configured to be capable of controlling stage lighting.

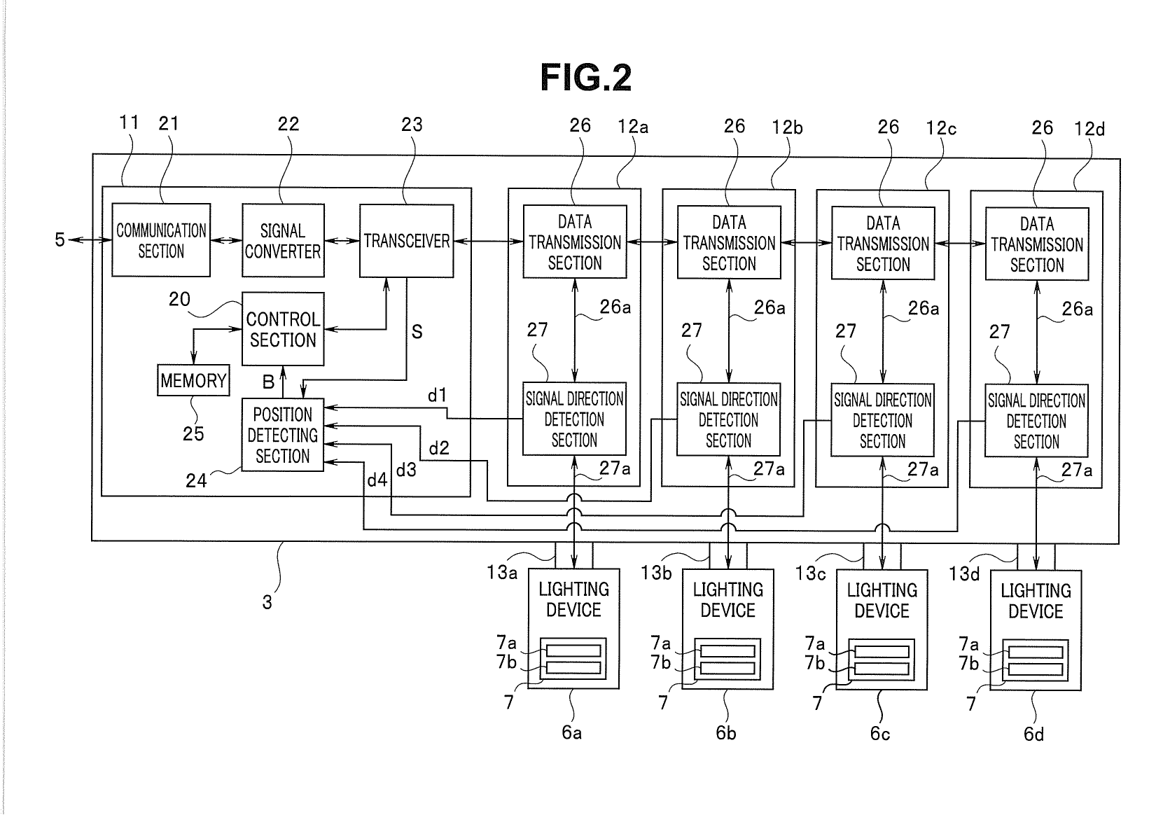

Next, a configuration of the batten 3 will be described. FIG. 2 is a block diagram illustrating the configuration of the batten 3.

The batten 3 is a lighting device installation apparatus in which a plurality of lighting devices 6 are connected and installed. Accordingly, the concept of the batten 3 is broad and its shape, dimension or the like is not limited to a batten of the related art.

The batten 3 has a node 11, a plurality of (herein, four) relay sections 12a, 12b, 12c and 12d (hereinafter, referred to as the relay section 12 when pointing all or one of the relay sections 12a, 12b 12c and 12d), and connectors 13a, 13b, 13c and 13d (hereinafter, referred to as the connector 13 when pointing all or one of the connectors 13a, 13b, 13c and 13d) to which a plurality (herein, four) of lighting devices 6a, 6b, 6c and 6d (hereinafter, referred to as the lighting device 6 when pointing all or one of the lighting devices 6a, 6b, 6c and 6d) can be connected. A connection position, that is, an installation position of each of the connectors 13 in each of the battens 3 is predetermined. Each of the connectors 13 configures a connection section to which the lighting device 6 is connected.

The node 11 is configured to include a control section 20, a communication section 21, a signal converter 22, a transceiver 23, a position detecting section 24 and a memory 25. Each section, for example, the control section 20 of the node 11 is realized by a semiconductor chip including the CPU.

The control section 20 is a processing section which includes the CPU, and performs functions of controlling the whole node 11 and acquiring identification information of each of the lighting devices 6 described below.

The communication section 21 is a processing section which performs a communication process via the communication line 5 configuring a communication network by the Ethernet (registered trademark) protocol to communicate with the operation console 2 that is an external apparatus. In other words, the communication section 21 is a communication section for communicating with the external apparatus using a predetermined communication protocol.

The signal converter 22 is a processing section which performs conversion between the Ethernet (registered trademark) protocol and Remote Device Management (RDM) protocol. The RDM protocol is a protocol which is capable of two-way communication using DMX512-A protocol (hereinafter, referred to as DMX protocol). The signal converter 22 is a protocol conversion section which converts the RDM protocol to the Ethernet (registered trademark) protocol and outputs the converted signal to the communication section 21 when receiving the signal from the transceiver 23, and converts the Ethernet (registered trademark) protocol to the RDM protocol and outputs the converted signal to the transceiver 23 when receiving the signal from the communication section 21.

The transceiver 23 is a transceiver which performs communication of the RDM protocol. The transceiver 23 transmits the signal from the signal converter 22 to the relay section 12 and transmits the signal from the relay section 12 to the signal converter 22. Furthermore, the transceiver 23 outputs destination information S included in the signal from the signal converter 22 to the position detecting section 24. The destination information S includes unique ID (UID) information. The UID is unique identification information which is set for each of the lighting devices 6.

The position detecting section 24 is a processing section which receives the destination information S from the transceiver 23 and position detecting signals d1, d2, d3 and d4 from the relay sections 12a, 12b 12c and 12d, and generates and outputs installation position information B of each of the lighting devices 6.

Each of the position detecting signals d1, d2, d3 and d4 (hereinafter, referred to as the position detecting signal d when pointing all or one of the position detecting signals d1, d2, d3 and d4) is input to a corresponding input terminal of four input terminals of the position detecting section 24, respectively. Accordingly, the position detecting section 24 can detect the relay section 12 from which the position detecting signal d is output, based on to which input terminal the position detecting signal d is input.

The memory 25 is a storage section which stores the UID as the unique identification information of each of the lighting devices 6 connected to the batten 3 and the installation position information B.

The plurality of relay sections 12 are connected to the node 11 in a so-called daisy chain form. Herein, the node 11 is connected to the relay section 12a and the relay section 12a is further connected to the relay section 12b in the downstream thereof. The relay section 12b is connected to the relay section 12c in the downstream thereof and the relay section 12c is further connected to the relay section 12d in the downstream thereof.

Each of the relay sections 12 is a signal relay section which is configured to include a data transmission section 26 and a signal direction detection section 27. In other words, each of the battens 3 has the plurality of relay sections which are connected to the plurality of corresponding connectors 13, respectively.

Each of the data transmission sections 26 is a two-way repeater which outputs the signal from the upstream side to both the relay section 12 on the downstream side and the lighting device 6, and, at the same time, outputs the signal from the relay section 12 on the downstream side and the lighting device 6 to the node 11 or the relay section 12 on the upstream side. For example, the data transmission section 26 of the relay section 12a outputs the signal from the node 11 to the relay section 12b and the lighting device 6a, and, at the same time, outputs the signal from the relay section 12b on the downstream side and the lighting device 6a to the node 11 on the upstream side.

The signal direction detection section 27 is a processing section which outputs a predetermined position detecting signal d when receiving the signal from the lighting device 6 connected to the relay section 12 to which the signal direction detection section 27 belongs. Data communication is performed between the data transmission section 26 and the signal direction detection section 27 via a signal line 26a, and the data communication is performed between the signal direction detection section 27 and the lighting device 6 via a signal line 27a. The signal direction detection section 27 detects whether the signal is received from the lighting device 6 and outputs a predetermined position detecting signal d when receiving the signal from the lighting device 6.

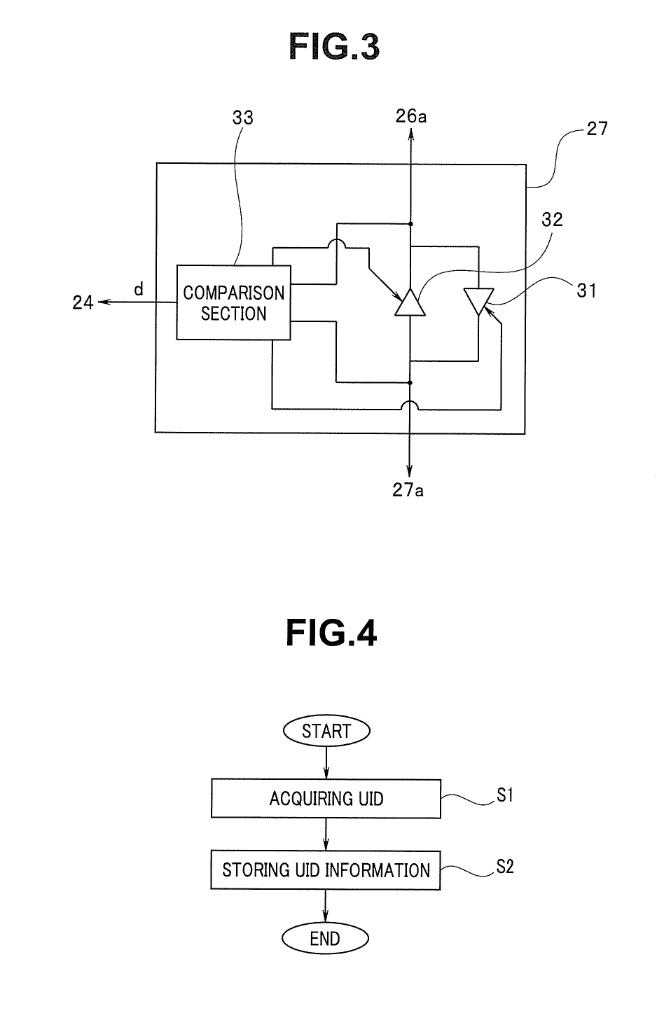

FIG. 3 is a circuit diagram of the signal direction detection section 27. As illustrated in FIG. 3, the signal direction detection section 27 includes two buffer circuits 31 and 32, and a comparison section 33. The buffer circuits 31 and 32 are connected in parallel between the data transmission section 26 and the lighting device 6 so as to output in opposite directions each other. The buffer circuit 31 is a circuit in which the signal is input from the data transmission section 26 and is output to the lighting device 6, and the buffer circuit 32 is a circuit in which the signal is input from the lighting device 6 and is output to the data transmission section 26.

The comparison section 33 inputs a voltage to both ends of a parallel circuit of the buffer circuits 31 and 32 and detects a time difference between fallings (or risings) of waveforms at both ends, and outputs the position detecting signal d, when the signal is generated from the lighting device 6 based on the time difference. In addition, the comparison section 33 controls ON•OFF of the buffer circuits 31 and 32 in response to the direction of the signal so that, for example, the signal passing through the buffer circuit 31 is not allowed to pass through the buffer circuit 32.

The data is communicated in a half-duplex mode between the data transmission section 26 and the lighting device 6. Herein, the signal from the data transmission section 26 is input to the buffer circuit 31 and is output to the lighting device 6 having a predetermined time delay. Similarly, the signal from the lighting device 6 is input to the buffer circuit 32 and is output to the data transmission section 26 having a predetermined time delay.

The comparison section 33 outputs the position detecting signal d indicating the presence of the signal which is output from the lighting device 6 by detecting difference between the fallings (or risings) of the signal waveforms at both ends of the parallel circuit of the buffer circuits 31 and 32.

Accordingly, the signal direction detection section 27 is provided corresponding to each of the connectors 13 and outputs a predetermined detection signal d when detecting the signal which is transmitted from the connector 13 to the relay section 12 that is a signal relay section. In other words, each of the battens 3 has a plurality of signal direction detection sections 27 which are provided corresponding to the plurality of connectors 13, respectively, and outputs a predetermined position detecting signal d when detecting the signal which is transmitted from the connector 13 to the relay section 12. In addition, in FIGS. 2 and 3, the data transmission section 26 and the signal direction detection section 27 are illustrated in separated bodies, but may be integrated. In other words, as described above, the data transmission section 26 also detects the direction of the signal to the upstream or the downstream so that the data transmission section 26 may be configured to serve as the signal direction detecting function section.

Referring back to FIG. 2, each of the lighting devices 6 has the non-volatile memory 7 and the memory 7 includes a storage section 7a for storing various types of specification information of the lighting device 6 and a storage section 7b for storing the UID that is the unique identification information of the lighting device 6. The various types of the specification information also include a DMX address or the like in addition to device information such as a type and output wattage.

In addition, each of the lighting devices 6 performs light-on and light-out, light modulation and color toning, posture control or the like in response to the received control signal such as light modulation signal and, at the same time, outputs a response signal including the information in response to various commands which are received via the signal line 27a. In other words, each of the lighting devices 6 is a lighting device which has the UID that is the identification information, the device information and the DMX address, and, at the same time, outputs the response signal when receiving an inquiry signal.

Operation

Next, a method by which the operation console 2 automatically acquires the device information, the installation position information or the like of the lighting device 6 from each of the battens 3 will be described using FIGS. 4 to 6.

FIG. 4 is a flowchart illustrating an example of a flow of the acquisition process of the UID in the batten 3.

As illustrated in FIG. 4, firstly, when the power supply is turned on in each of the battens 3, the control section 20 of the node 11 acquires the identification information (hereinafter, referred to as the UID) of the lighting device 6 connected to each of the relay sections 12 in the downstream thereof (Act1). The process of ACT1 configures the identification information acquiring section which acquires the UIDs that are the pieces of identification information of the plurality of lighting devices 6 connected to the plurality of connectors 13.

The UID is the unique identification information of the lighting device 6 configured of a plurality of bits (for example, 48 bits) and is stored in the storage section 7b as described above. For example, the control section 20 acquires the UID of the lighting device 6 connected to each of the relay sections 12 by the binary tree method which is known in the related art.

Particularly, the control section 20 transmits the signal, which inquires as to whether or not any of the lighting devices 6 has the UID of 48 bits of a predetermined initial value, to the relay section 12 in the downstream thereof. The control section 20 can acquire the UID of the lighting device 6 connected to each of the relay sections 12 by repeating the transmission of the inquiry signal which changes the value of the bit in order from the uppermost bit of 48 bits, based on the presence or absence of a reply from the lighting device 6 in response to the UID which is transmitted.

The control section 20 can specify and acquire the UID of the four lighting devices 6 connected to the four connectors 13 by repeating the above-described process and the control section 20 of the node 11 stores acquired UID information in the memory 25 (ACT2). Accordingly, the memory 25 configures a storage section which stores the UIDs that are the pieces of acquired identification information of the plurality of lighting devices 6.

All battens 3 perform the process illustrated in FIG. 4 so that each of the battens 3 stores the pieces of UID information of the plurality (four in this case) of lighting devices 6 connected thereto in the memory 25.

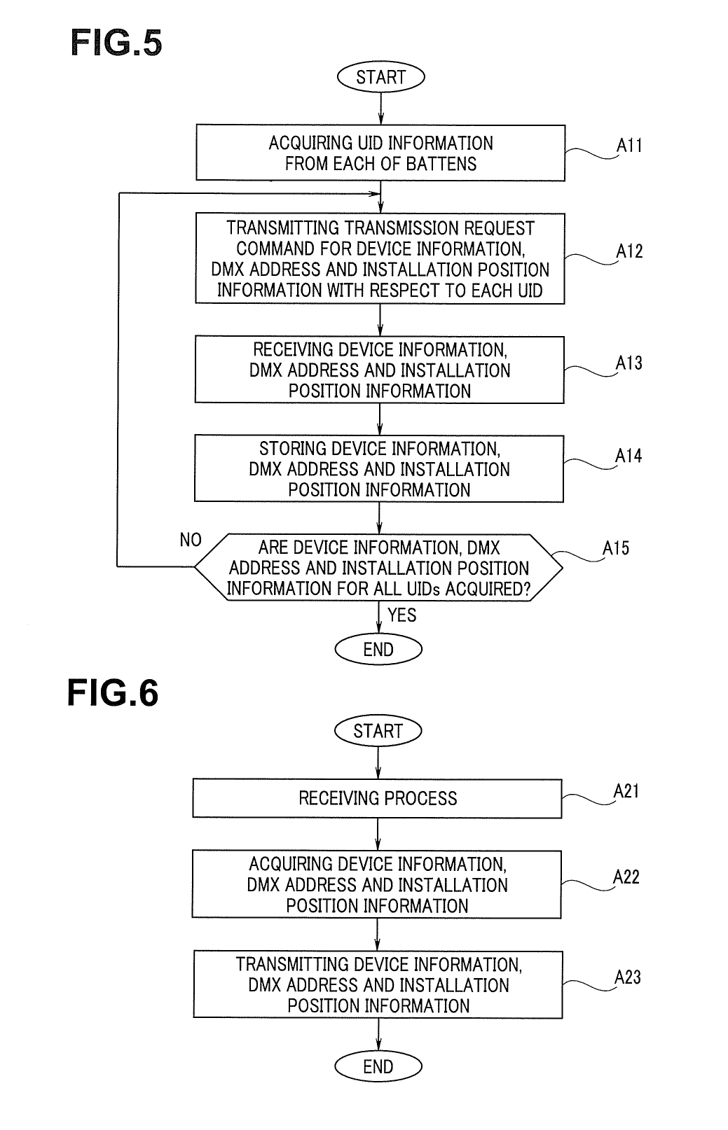

Next, when the operator performs a predetermined operation on the operation console 2, the process of FIG. 5 is performed.

FIG. 5 is a flowchart illustrating an example of the flow of the process for acquiring the installation position information of each of the lighting devices 6, in the operation console 2. As described above, the communication between each of the battens 3 and the operation console 2 is performed according to the Ethernet (registered trademark) protocol.

Firstly, the control section 2a of the operation console 2 acquires the UID information of the lighting device 6 stored in the memory 25 from all battens 3 (ACT11). Since the operation console 2 has the address information of each of the battens 3 (in other words, the node 11), the control section 2a can receive and acquire pieces of the UID information from all battens 3 by sending the transmission request for the UID information to the plurality of battens 3 in order. Since each of the battens 3 is given a batten number in advance and a correlation between the address of the batten 3 and the batten number is also predetermined, the control section 2a can store the batten number and the UID in association with each other.

The control section 2a transmits the transmission request command for the device information, the DMX address and the installation position information with respect to each UID, based on the pieces of acquired UID information when acquiring the pieces of UID information from all nodes (ACT12).

The control section 2a transmits the transmission request command for the device information or the like to the batten 3, to which the lighting device 6 having the UID thereof is connected, for each UID. Since the operation console 2 has the address information of the node 11 of each of the battens 3, the operation console 2 can transmit the transmission request command to the batten 3 corresponding to the UID, based on the address information thereof.

FIG. 6 is a flowchart illustrating an example of the flow of the process when receiving the transmission request command for the device information in each of the nodes 11.

Receiving process for the transmission request command transmitted from the operation console 2 is performed by the communication section 21 of the node 11 (ACT21). The received transmission request command is converted from the Ethernet (registered trademark) protocol to the RDM protocol in the signal converter 22 and is received by the transceiver 23 and then is transmitted to each of the relay sections 12. At the same time, the transceiver 23 outputs the destination information S having the UID information included in the received transmission request command to the position detecting section 24.

Each of the relay sections 12 transmits the command received by the data transmission section 26 to the lighting device 6 via the signal direction detection section 27 and, at the same time, also outputs the command to the relay section 12 in the downstream. Only the lighting device 6 having the UID specified in the received command outputs the device information and the DMX address stored in the memory 7a to the data transmission section 26. At this time, the signal direction detection section 27 detects that the data of the device information and the DMX address are input from the signal line 27a. The signal direction detection section 27 outputs the position detecting signal d.

For example, when receiving the position detecting signal d (d1) from the relay section 12a, the position detecting section 24 outputs, to the control section 20, the installation position information B (B1) which indicates that the device information or the like from the lighting device 6a connected to the connector 13a is output as the response signal.

Similarly, when receiving the position detecting signal d (d2) from the relay section 12b, the position detecting section 24 outputs, to the control section 20, the installation position information B (B2) which indicates that the device information or the like from the lighting device 6b connected to the connector 13b is output as a response signal.

Accordingly, the position detecting section 24 configures an installation position information output section which generates and outputs the installation position information B of the lighting device 6 having the UID, based on a predetermined position detecting signal d which is output from the signal direction detection section 27, when the response signal in response to the inquiry signal to the lighting device 6 having the UID information is output to any of the plurality of relay sections 12 from the operation console 2 that is an external apparatus.

The device information and the DMX address from the lighting device 6 are received via the data transmission section 26 by the transceiver 23, and the control section 20 acquires the installation position information B of the lighting device 6 relating to the UID included in the received destination information S (ACT22).

Then, the control section 20 controls the transceiver 23 and then transmits the device information, the DMX address and the installation position information B relating to the received UID to the operation console 2 (ACT23). In other words, the control section 20 controls the transceiver 23 to transmit the installation position information B together with the response signal, which is output from the position detecting section 24 that is the installation position information output section, to the operation console 2 that is an external apparatus via the communication section 21.

Referring back to FIG. 5, the control section 2a receives the device information, the DMX address and the installation position information B from the batten 3 in response to the transmission request command which is transmitted (ACT13).

The control section 2a stores the device information, the DMX address and the installation position information B which are received in the storage section 2b in association with the UID in response to the transmission request command (ACT14).

The control section 2a determines whether or not the device information, the DMX address and the installation position information B for all UIDs are acquired (ACT15) and if the device information and the like for all UIDs are not acquired (ACT15: NO), the process returns to ACT12.

If the device information and the like for all UIDs are acquired (ACT15: YES), the control section 2a ends the process.

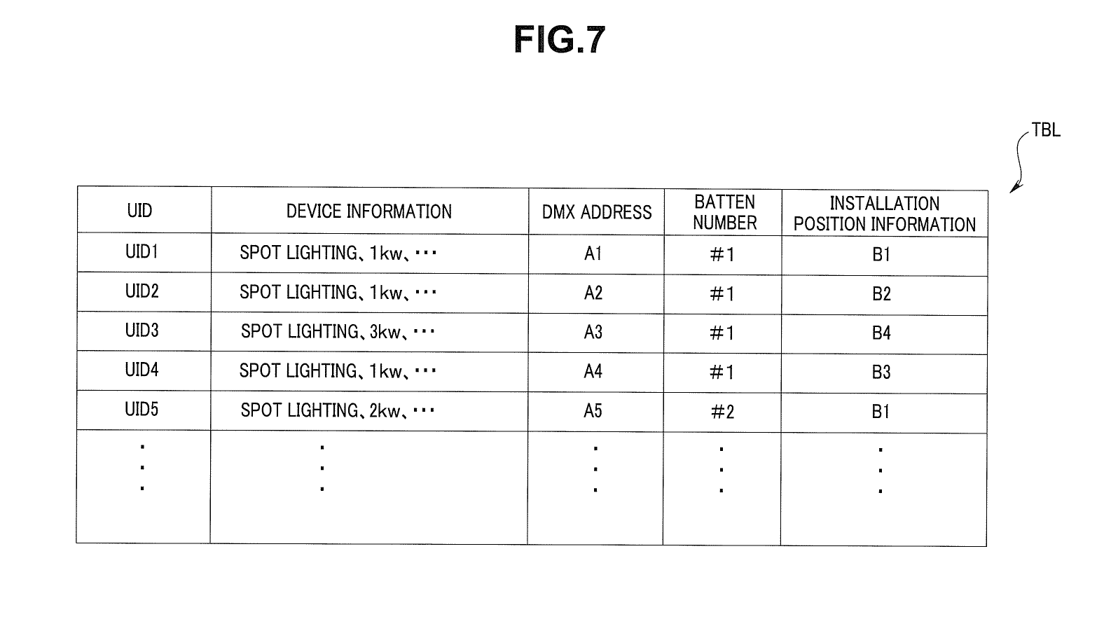

FIG. 7 is a view illustrating an example of a lighting device information table TBL stored in the storage section 2b of the operation console 2. The lighting device information table TBL stores each type of information such as the UID, the device information, the DMX address, the batten number and the installation position information. The UID and batten number information in the lighting device information table TBL is the information acquired in ACT11. The device information, the DMX address and the installation position information are the information acquired in ACT13.

Since the lighting device information table TBL stores the device information, the DMX address, the batten number and the installation position information for each UID that is the unique identification information, the operator can display the lighting device information table TBL itself on the screen of the display section 2d of the operation console 2. Accordingly, the operator can grasp which lighting device is installed, that is, connected to which position of which batten by looking at the lighting device information table TBL.

In addition, since a predetermined DMX address is stored in the storage section 7a when the lighting device 6 is manufactured, the predetermined address information is stored in the lighting device information table TBL. The operator can change the DMX address when the lighting device information table TBL is displayed on the screen 41.

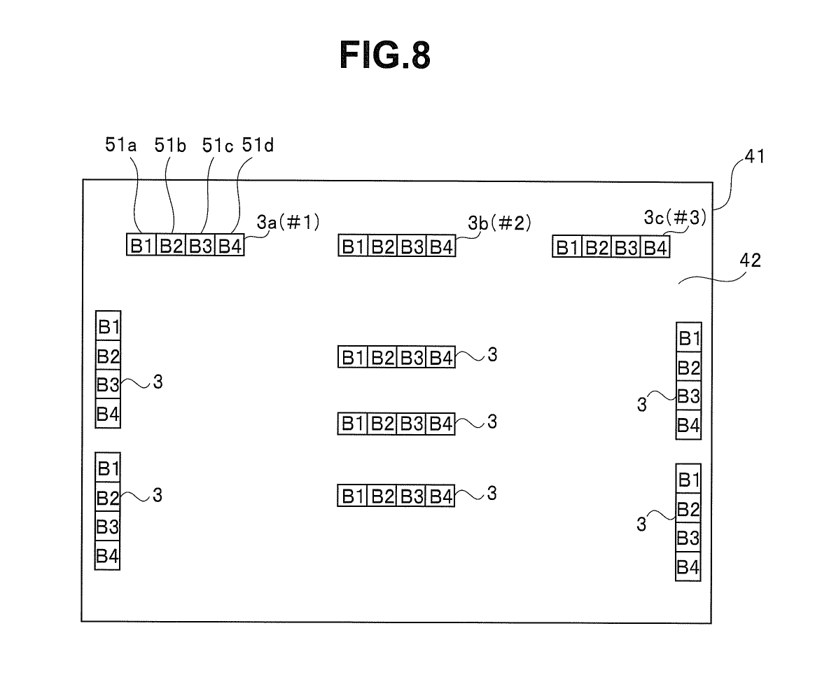

FIG. 8 is a view illustrating an example of a screen showing the lighting device arrangement on a stage that is displayed on the screen of the display section 2d of the operation console 2. The screen 41 illustrated in FIG. 8 is referred to when the operator controls each of the lighting devices.

The screen 41 in FIG. 8 illustrates a layout of the plurality of battens 3 hung from a ceiling of a stage 42. The figure of the batten 3 is displayed on the screen 41. It is illustrated that the batten number of the batten 3a is #1, the batten number of the batten 3b is #2 and the batten number of the batten 3c is #3. Similarly, the batten numbers are given to other battens 3. A figure of each of the battens 3 includes display areas 51a, 51b, 51c and 51d corresponding to four connectors 13.

Furthermore, the operator can select any lighting device 6 of any batten 3 in the plurality of battens 3 displayed on the screen 41 by operating the input section 2c and can display a control state of the batten 3 or the lighting device 6 which is selected on the screen 41, based on the information from the lighting device information table TBL. Furthermore, the operator can instruct the operation console 2 to output the control signal or the light modulation signal with respect to the batten 3 or the lighting device 6 which is selected.

Accordingly, the control state of each of the lighting devices 6 or the output instruction of the light modulation signal can be also displayed on the screen by associating the device information of the lighting device 6 with four connectors 13a, 13b, 13c and 13d of each of the battens 3 on the screen 41, based on the lighting device information table TBL in FIG. 7.

As described above, according to the above embodiment, since the operation console 2 can automatically acquire the device information, the installation position information or the like of each of the lighting devices 6 from each of the battens 3, the lighting batten and lighting system, in which the attachment position of the lighting device can be easily grasped in each of the battens in the operation console 2 that is a upper-level fixture can be realized.

In addition, especially, other protocol protocols can also be used as a communication protocol if the intended function of the embodiment can be fulfilled.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting batten comprising:
a communication section for communicating with an external apparatus using a predetermined communication protocol;
a plurality of connection sections to which a plurality of lighting devices which have identification information and device information and output a response signal when receiving a predetermined inquiry signal are connected;
a plurality of signal relay sections which are connected to the plurality of corresponding connection sections, respectively;
a plurality of signal direction detection sections which are provided corresponding to the plurality of connection sections, respectively, each of the plurality of signal direction detection sections outputting a predetermined detection signal when detecting a signal which is transmitted respectively from each of the plurality of connection sections to each of the plurality of signal relay sections; and
an installation position information output section which generates and outputs installation position information of one of the plurality of lighting devices having the identification information, based on the predetermined detection signal which is output from one of the plurality of signal direction detection sections when the response signal in response to the predetermined inquiry signal to each of the plurality of lighting devices having the identification information is output to one of the plurality of signal relay sections from the external apparatus.

2. The batten according to claim 1, further comprising:
a control section which performs control such that the installation position information output from the installation position information output section is transmitted, together with the response signal, to the external apparatus via the communication section.

3. The batten according to claim 1, further comprising:
an identification information acquiring section which acquires the identification information of the plurality of lighting devices connected to the plurality of connection sections, and
a storage section which stores the acquired identification information of the plurality of lighting devices.

4. The batten according to claim 1,
wherein the installation position information output section has a plurality of input terminals corresponding to each of the predetermined detection signals and generates the installation position information by detecting which one of the plurality of signal direction detection sections that outputs the predetermined detection signal, based on to which input terminal the predetermined detection signal is input.

5. The batten according to claim 1,
wherein each of the plurality of signal relay sections outputs the signal from the communication section to other signal relay sections and a corresponding one of the plurality of connection sections, and has a two-way repeater which outputs the signal from the other relay sections and the corresponding connection sections to the communication section.

6. A lighting system comprising: a control device, a plurality of lighting battens which communicate with the control device via a communication line using a predetermined protocol and a plurality of lighting devices provided in each of the plurality of lighting battens,
wherein each of the plurality of lighting battens includes:
a communication section for communicating with the control device using the predetermined communication protocol;
a plurality of connection sections to which the plurality of lighting devices which have identification information and device information, and output a response signal when receiving a predetermined inquiry signal are connected;
a plurality of signal relay sections which are connected to the plurality of corresponding connection sections, respectively;
a plurality of signal direction detection sections which are provided corresponding to the plurality of connection sections, respectively, each of the plurality of signal direction detection sections outputting a predetermined detection signal when detecting a signal which is transmitted respectively from each of the plurality of connection sections to each of the plurality of signal relay sections;
an installation position information output section which generates and outputs installation position information of one of the plurality of lighting devices having the identification information, based on the predetermined detection signal which is output from one of the plurality of the signal direction detection sections when the response signal in response to the predetermined inquiry signal to each of the plurality of lighting devices having the identification information is output to one of the plurality of signal relay sections from the external apparatus; and
a control section which performs control such that the installation position information output from the installation position information output section is transmitted, together with the response signal, to the control device via the communication section.

7. The system according to claim 6,
wherein the control device has a storage section which stores the installation position information received in response to the inquiry signal in association with the identification information.

8. The system according to claim 7,
wherein the storage section stores the device information of one of the plurality of lighting devices received in response to the inquiry signal together with the installation position information in association with the identification information.

9. The system according to claim 7,
wherein the storage section stores a batten number given to each of the plurality of lighting battens in association with the identification information.

10. The system according to claim 6,
wherein each of the plurality of lighting battens further includes:
an identification information acquiring section which acquires the identification information of the plurality of lighting devices connected to the plurality of connection sections; and
a storage section which stores the acquired identification information of the plurality of lighting devices.

11. The system according to claim 6,
wherein the installation position information output section has a plurality of input terminals corresponding to each of the predetermined detection signals and generates the installation position information by detecting which one of the plurality of signal direction detection sections that outputs the predetermined detection signal, based on to which input terminal the predetermined detection signal is input.

12. The system according to claim 6,
wherein each of the plurality of signal relay sections outputs the signal from the communication section to other signal relay sections and a corresponding one of the plurality of connection sections, and has a two-way repeater which outputs the signal from the other relay sections and the corresponding connection section to the communication section.

13. The system according to claim 6,
wherein each of the plurality of lighting devices is a lighting device which uses a light emitting diode.
